(19) United States
(12) Patent Application Publication
(10) Pub. No.: US 2016/0262192 A1
(43) Pub. Date: Sep. 8, 2016

(54) System for Providing Internet Access Using Mobile Phones

(71) Applicant: Nextivity, Inc., San Diego, CA (US)

(72) Inventors: Werner Richard Sievers, Poway, CA (US); Joseph Barry Schmeizer, San Diego, CA (US); Michiel Petrus Lotter, San Diego, CA (US)

(21) Appl. No.: 15/061,892

(22) Filed: Mar. 4, 2016

Related U.S. Application Data
(60) Provisional application No. 62/128,332, filed on Mar. 4, 2015.

(51) Int. Cl. H04W 76/02

(52) U.S. Cl. CPC H04W 76/02; H04W 88/16

(57) ABSTRACT

A system and method for providing internet access using mobile devices is disclosed. A gateway/router device of a local environment selects at least one mobile device located within the local environment, the selecting being based on the at least one mobile device having a wireless connection to the internet. The gateway/router device established a local connection with the selected at least one mobile device, the local connection for communicating data signals between the at least one mobile device and the gateway/router device on a first hop, and for communicating the data signals between the selected at least one mobile device and the internet on a second hop via the wireless connection between the at least one mobile device and the internet. The gateway/router device communicates the data signals between at least one other internet-enabled device within the local environment.

### CROSS-REFERENCE TO RELATED APPLICATION

This application claims priority to and the benefit of U.S. Provisional Patent Application No. 62/128,332, filed on Mar. 4, 2015 and titled “System for Providing Internet Access Using Mobile Phones,” the disclosure of which is incorporated by reference in its entirety.

### TECHNICAL FIELD

The subject matter described herein relates to wireless networks, and more particularly to a system and method for providing internet access using mobile phones.

### BACKGROUND

Internet access at home or in a small business environment today is not a luxury but a necessity. Such internet access is mainly provided by means such as Cable Modems, xDSL links or Fiber-to-the-Home connections. These connections provide high speed access with high availability. However, these connections are not of the same quality as corporate managed connections and they can and do fail, leaving the home or small business without an internet connection.

A typical home or small business network setup 100 is shown in FIG. 1. The setup 100 includes a home Gateway or Router 102 that is connected to the Internet 104 via a primary fixed line connection 106. The Gateway or Router 102 in turn connects with a variety of Internet-enabled devices 112 such as mobile phones, laptop computers, desktop computers, printers, etc., via at least one of a wireless connection 110 and/or fixed wired connection 108.

In addition to getting internet access via the fixed connections outlined above, most consumers today also access the internet using their mobile telephones or smartphones. New technologies such as LTE can indeed provide extremely fast connections to the internet, sometimes even rivaling fixed line connections. As the mobile network is independent of the fixed line network typically providing internet access at a residence or small business it is likely that when the fixed line internet connection fails, mobile internet connections would still be operational.

### SUMMARY

In this invention disclosure, a system is foreseen where a router or similar device in a home would normally be connected to the internet via a fixed line connection, but when the fixed line connection fails, it uses the mobile phones of the residents in the home as a backup internet connection.

In one aspect, a network setup, and method of operating the same, uses a mobile phone as a backup internet connection. In other aspects, multiple mobile phones can be used as a backup internet connection. In yet another aspect, a network setup, and method for operating the same, uses channel bonding for increased throughput.

In another aspect, a method for providing internet access using mobile devices is presented. The method includes selecting, by a gateway/router device of a local environment, at least one mobile device located within the local environment. The selecting is based on the at least one mobile device having a wireless connection to the internet. The method further includes establishing, by the gateway/router device, a local connection with the selected at least one mobile device. The local connection is for communicating data signals between the at least one mobile device and the gateway/router device on a first hop, and for communicating the data signals between the selected at least one mobile device and the internet on a second hop via the wireless connection between the at least one mobile device and the internet. The method further includes communicating, by the gateway/router device, the data signals between at least one other internet-enabled device within the local environment.

In yet another aspect, a system for providing internet access using mobile devices is presented. The system includes a gateway/router device that services a local environment. The gateway/router device includes logic for selecting at least one mobile device located within the local environment, the selecting being based on the at least one mobile device having a wireless connection to the internet. The system further includes a first local connection from the gateway/router device for communicating with the selected at least one mobile device, the first local connection for communicating data signals between the at least one mobile device and the gateway/router device on a first hop, and for communicating the data signals between the selected at least one mobile device and the internet on a second hop via the wireless connection between the at least one mobile device and the internet. The system further includes a second local connection from the gateway/router device for communicating with at least one other internet-enabled device, and for communicating the data signals between at least one other internet-enabled device within the local environment.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a typical home or small business network setup;

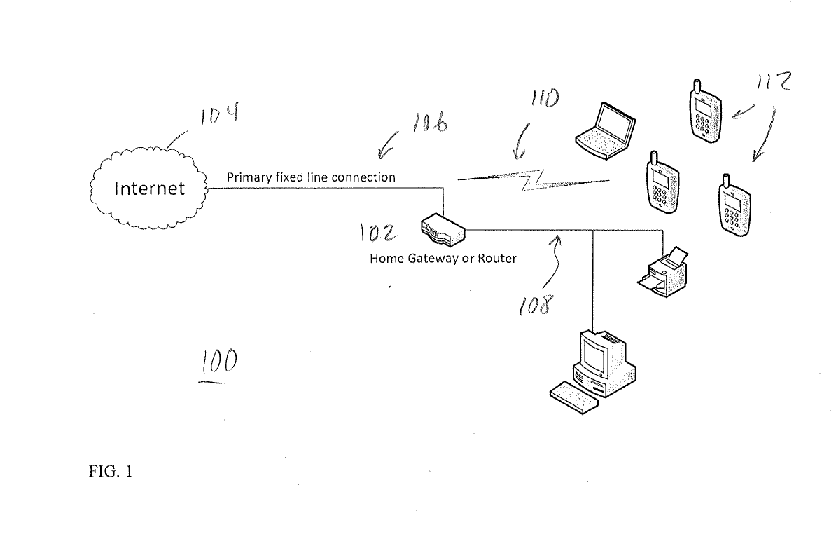

FIG. 2 illustrates a network setup using a mobile phone as a backup internet connection.

FIG. 3 illustrates a network setup using multiple mobile phones as a backup internet connection.

FIG. 4 illustrates a network setup using channel bonding for increased throughput.

When practical, similar reference numbers denote similar structures, features, or elements.

### DETAILED DESCRIPTION

This document discloses a system and method in which a router or similar device in a home would normally be connected to the internet via a fixed line connection, but when the fixed line connection fails, it uses the mobile phones of the residents in the home as a backup internet connection. This is different from established prior art that would have a dedicated cellular backhaul connection that can be used as an internet connection in case a fixed line connection fails.

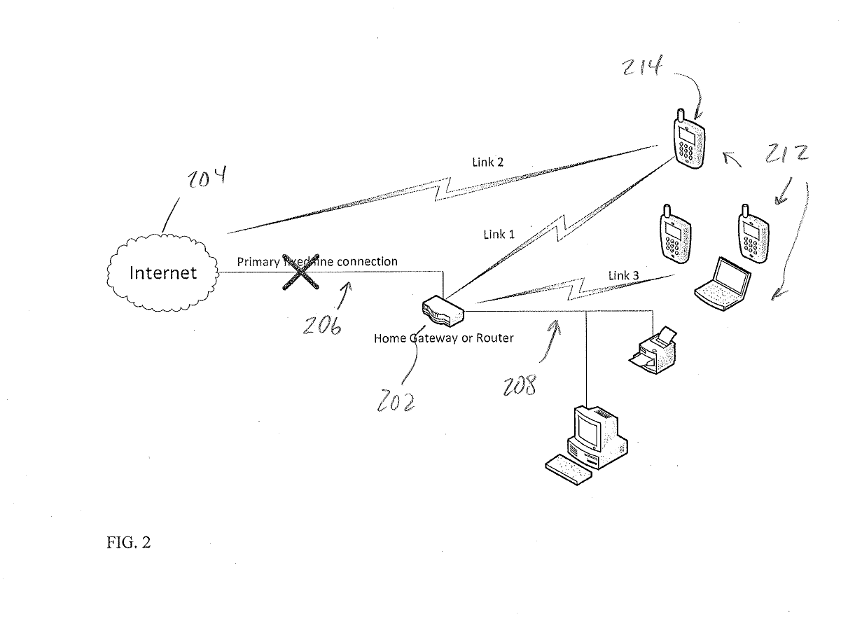

In accordance with some implementations, a system 200 for executing a method is shown in FIG. 2. The system 200 includes a home Gateway or Router 202 that is typically connected to the Internet 204 via a primary fixed line connection 206. The Gateway or Router 202 (“router”) in turn connects with a variety of Internet-enabled devices 212 such as mobile phones, laptop computers, desktop computers, printers, etc., via at least one of one or more wireless connections and/or fixed wired connections 208

As shown in FIG. 2, Link 1 represents a link between a selected mobile device 214 in the home and the router 202 in which the backhaul, primary fixed line connection 206 has failed. The selected mobile device 214 can be a mobile or cellular phone, a laptop computer, a tablet computer, or the like. Link 1 can be a wireless link such as WiFi or Bluetooth, or could even be a physical link such as a USB cable. Link 2 represents the selected mobile device's 214 link to the Internet 204 via a cellular phone network. Link 3 represents the local links between the router and local Internet-enabled devices 212 using internet services via the home gateway or router 202. Link 3 can be wired, wireless or any combination thereof.

In some implementations, the Gateway or Router 202 will normally access the internet via the fixed line connection 206. When this link goes down, the Gateway or Router 202 will search for a nearby mobile device to select and connect to in order to set up Link 1. Once the selected mobile device 214 is selected, Link 1 has been established, the router will send all internet traffic received on Link 3 onto Link 1 to the mobile device, which in turn provides the backhaul access. The selected mobile device 214 will then send all information received on Link 1 to the Internet 204 via Link 2. The reverse process would happen for information received from Link 2 destined for the Gateway or Router 202.

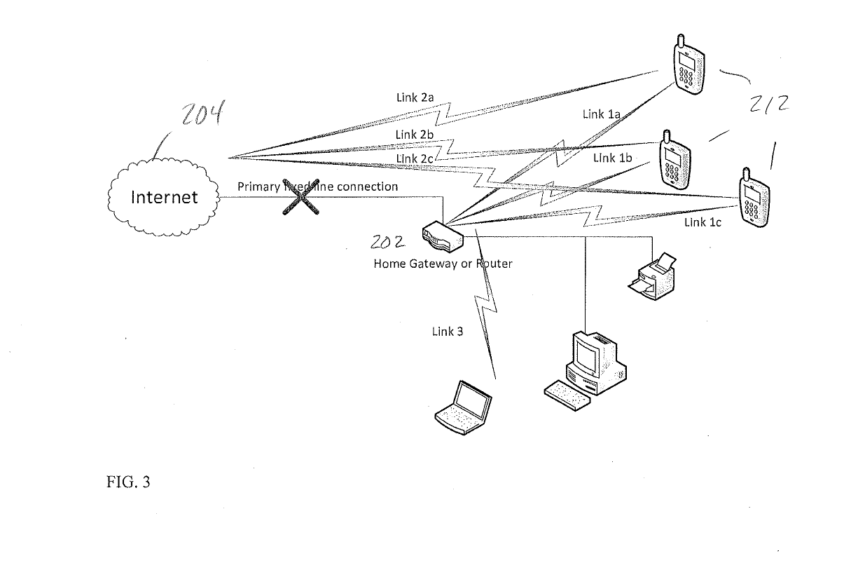

In alternative implementations, the router or home gateway may set up multiple connections to mobile devices 212 in the home to provide backup internet access. This is shown in FIG. 3. In this case, multiple Link 1's and Link 2's are established (shown as Link 1a, Link 1b and Link 1c). In this case the router or gateway may use any of a number of channel bonding algorithms to connect the Link 2's into a larger “fat pipe” to provide the home or business with a higher speed backup internet connection.

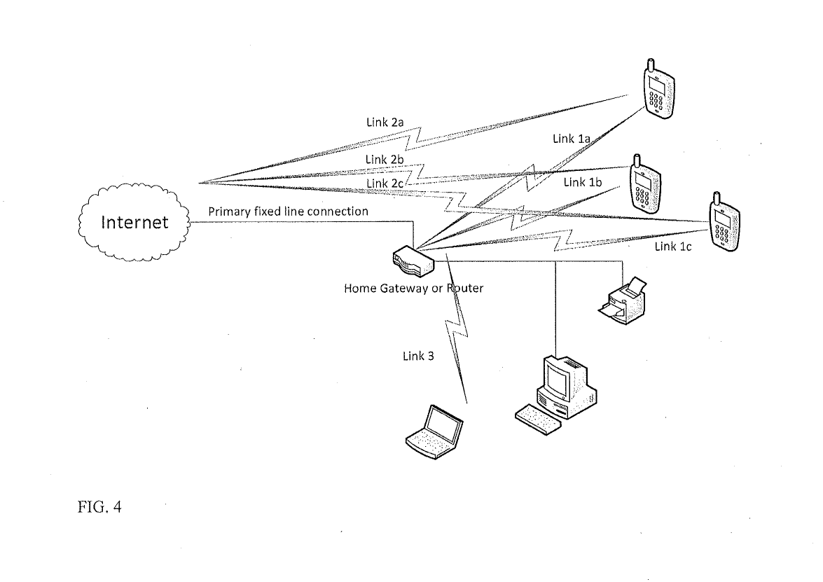

In yet other implementations, the system can be also be used to enhance overall internet speed available to devices connected to the gateway or router 202. In this scenario, the overall function of the system is similar to that described above and shown in FIG. 3, but in this case, the primary fixed line connection is functional and capable of providing access to the internet for the gateway or router. This scenario is shown in FIG. 4. In this case, the internet access speed offered by the gateway or router 202 is increased over and above that which is offered by the primary fixed line connect. This is achieved by the router or gateway distributing the internet traffic not only to the Primary Fixed Line connection, but also bonding Links 1a, 1b and 1c and Links 2a, 2b and 2c as described above with the primary fixed line link to create a “fatter” pipe, i.e. a connection with greater bandwidth and throughput, to the Internet 204.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method for providing internet access using mobile devices, the method comprising:
selecting, by a gateway/router device of a local environment, at least one mobile device located within the local environment, the selecting being based on the at least one mobile device having a wireless connection to the internet;
establishing, by the gateway/router device, a local connection with the selected at least one mobile device, the local connection for communicating data signals between the at least one mobile device and the gateway/router device on a first hop, and for communicating the data signals between the selected at least one mobile device and the internet on a second hop via the wireless connection between the at least one mobile device and the internet; and
communicating, by the gateway/router device, the data signals between at least one other internet-enabled device within the local environment.

2. The method in accordance with claim 1, wherein the wireless connection to the internet by the selected at least one mobile device is a cellular data connection.

3. The method in accordance with claim 1, wherein the local connection with the selected at least one mobile device is a wireless data connection.

4. The method in accordance with claim 3, wherein the wireless data connection is one of a WIFI connection and a Bluetooth connection.

5. The method in accordance with claim 1, wherein communicating the data signals between the at least one other internet-enabled device within the local environment is via a second wireless connection between the gateway/router device the at least one other internet-enabled device within the local environment.

6. The method in accordance with claim 1, wherein communicating the data signals between the at least one other internet-enabled device within the local environment is by a wired connection between the gateway/router device the at least one other internet-enabled device within the local environment.

7. A system for providing internet access using mobile devices, the system comprising:
a gateway/router device that services a local environment, the gateway/router device selecting at least one mobile device located within the local environment, the selecting being based on the at least one mobile device having a wireless connection to the internet;
a first local connection from the gateway/router device for communicating with the selected at least one mobile device, the first local connection for communicating data signals between the at least one mobile device and the gateway/router device on a first hop, and for communicating the data signals between the selected at least one mobile device and the internet on a second hop via the wireless connection between the at least one mobile device and the internet; and
a second local connection from the gateway/router device for communicating with at least one other internet-enabled device, and for communicating the data signals between at least one other internet-enabled device within the local environment.

8. The system in accordance with claim 7, wherein the wireless connection to the internet by the selected at least one mobile device is a cellular data connection.

9. The system in accordance with claim 7, wherein the local connection with the selected at least one mobile device is a wireless data connection.

10. The system in accordance with claim 9, wherein the wireless data connection is one of a WIFI connection and a Bluetooth connection.

11. The system in accordance with claim 7, wherein communicating the data signals between the at least one other internet-enabled device within the local environment is via a second wireless connection between the gateway/router device the at least one other internet-enabled device within the local environment.

12. The system in accordance with claim 7, wherein communicating the data signals between the at least one other internet-enabled device within the local environment is by a wired connection between the gateway/router device the at least one other internet-enabled device within the local environment.
